(19) United States
(12) Patent Application Publication
(10) Pub. No.: US 2016/0318432 A1
(43) Pub. Date: Nov. 3, 2016

(54) COMPOSITE MEMBER AND SEAT SHELL

(71) Applicant: JOHNSON CONTROLS TECHNOLOGY COMPANY, Plymouth, MI (US)

(72) Inventors: Bernd ZIMMERBEUTEL, Remscheid (DE); Nils MAGNUS, Remscheid (DE); Marian STEPANKOWSKY, Stuttgart (DE); Guido KUNZ, Ettlingen (DE)

(21) Appl. No.: 15/108,120

(22) PCT Filed: Dec. 22, 2014
(86) PCT No.: PCT/EP2014/079003

§ 371 Date: Jun. 24, 2016

(30) Foreign Application Priority Data
Dec. 27, 2013 (DE) 10 2013 114 885.9

(51) Int. Cl. B60N 2/68; B32B 15/08; C09D 5/10

(52) U.S. Cl. CPC B60N 2/686; C09D 5/106; B32B 15/08; B32B 2307/714; B32B 2307/734; B32B 2605/003; B32B 2250/40

(57) ABSTRACT

A composite member (1) for manufacturing motor vehicle seats and motor vehicle parts, includes a central layer (1.3) and outer layers (1.1, 1.2) on the outside of the central layer (1.3). In order to provide a composite member (1) which is used for manufacturing motor vehicle seats and motor vehicle parts and which can be produced at a low cost in a particularly simple manner, has great dimensional stability and rigidity, exhibits particularly high resistance to mechanical loads, and has a particularly low dead weight, the central layer (1.3) is made of a plastic material and the outer layers (1.1, 1.2) are made of sheet metal.

### CROSS REFERENCE TO RELATED APPLICATIONS

This application is a United States National Phase Application of International Application PCT/EP2014/079003 filed Dec. 22, 2014 and claims the benefit of priority under 35 U.S.C. §119 of German Patent Application 10 2013 114 885.9 filed Dec. 27, 2013 the entire contents of which are incorporated herein by reference.

### FIELD OF THE INVENTION

The invention relates to a composite member for producing motor-vehicle seats and motor-vehicle components, having
a central layer and
outer layers, which are arranged on the outside of the central layer. The invention also relates to a seat shell.

### BACKGROUND OF THE INVENTION

Composite members of the type mentioned in the introduction are known in a wide variety of configurations from the prior art and are used there as motor-vehicle components. WO 2010/003842 A1 discloses a vehicle load-bearing structure which is made of a core material which is arranged between metal panels and consists of an impact-resistant, thermoplastic material.

In particular, large-surface-area lightweight components such as body parts and seat shells are produced in the form of composite members which comprise fiber composite plastics. Composite members here have the advantage over components made of a sheet metal, for example from steel, aluminum or magnesium, that a lower weight can be achieved. Such a composite member is produced here usually by the application, and adhesive bonding, of a plurality of material layers arranged one above the other, this disadvantageously resulting in a high level of production outlay and high production costs.

It is also known from the prior art, in order to achieve sufficient dimensional stability and rigidity, for components made of a high-strength material, in particular of sheet metal, to be arranged, at least in part, on regions of the composite member which are subjected to particularly pronounced mechanical loading. However, this requires additional production of these components with a shape which corresponds to those regions of the composite member which are to be reinforced, and this results, on the one hand, in a further increase in the production costs and in the level of production outlay and also in an increased overall weight of the finished composite member.

### SUMMARY OF THE INVENTION

It is therefore an object of the invention to provide a composite member which is intended for producing motor-vehicle seats and motor-vehicle components and is particularly straightforward to produce in a cost-effective manner, has a high level of dimensional stability and rigidity, withstands mechanical loading to particularly good effect and is of particularly low weight. It is a further object of the invention to specify an improved seat shell.

The composite member according to the invention for producing motor-vehicle seats and motor-vehicle components comprises a central layer and outer layers, which are arranged on the outside of the central layer, wherein the central layer is formed from a plastics material and the outer layers are formed from a sheet metal.

Arranging outer layers made of sheet metal on either side of a central layer made of plastics material allows particularly straightforward production of a three-dimensional composite member, for example by deep drawing or pressing, as a result of which production can take place particularly advantageously in a single operating step. Arranging a respective outer layer made of sheet metal on either side also results in a high level of dimensional stability, and also in good mechanical loading capability, in particular of the surface, of the composite member.

Having the central layer formed from plastics material particularly advantageously makes it possible to reduce a weight of the central layer and thus an overall weight of the composite arrangement. A so-called sandwich construction, in which the central layer is coated on either side by a respective outer layer, makes it possible for the dimensional stability, in particular a flexural rigidity and rigidity when subjected to elongation, to be maintained at least as far as possible.

A composite member is understood here to mean, in principle, any three-dimensional member which is formed essentially from a composite material. The composite member is a component for a motor vehicle, in particular for a motor-vehicle seat, which is formed preferably essentially in one piece. It may be constituted here both by large-surface-area parts of the vehicle body, for example a trunk-lid structure, an engine hood or a door module, and by structures installed in the interior of the vehicle, for example a vehicle-seat component, a seat shell and a covering or shelf.

Outer layers are understood to mean, in principle, those material layers of the composite member which form the essential parts of the outer surface thereof. The outer layers here extend, preferably essentially over their entire surface area, over the entire composite member. In principle, the outer layers are to be understood to mean cover layers which are formed from a metal, in particular steel and/or aluminum, and/or fiber composite plastics, it therefore being possible to ensure the dimensional stability, in particular the rigidity when subjected to elongation and/or flexural rigidity. Via the outer layers, it is possible to compensate, at least as far as possible, for loading, for example shocks and/or vibrations, to which the composite member is subjected during operation of the motor vehicle.

It is possible here for the sheet metal to be formed from a single material over its entire thickness or else to have a layered structure. In particular, it is possible for one or both surfaces of one or each of the two outer layers to have one or more coatings arranged one above the other, for example for corrosion protection or for improving the connection to the central layer. Such a central layer is likewise to be understood to mean a core layer, which is connected to the two outer layers in particular in tension-resistant and shear-resistant manner, this resulting in a joint load-bearing action of the composite arrangement being achieved. The central layer is, in principle, that region of the composite member which is bounded by the two outer layers. The central layer can be connected to the outer layers, in the first instance, in any desired manner. The connection is preferably achieved by pressing and/or adhesive bonding.

It is possible, in principle, for the central layer both to be formed homogenously from a single material and to have a layered structure. The central layer is preferably formed from a plastics material which is essentially homogenous particularly preferably in all directions of space. The plastics material may be, in principle, any desired plastics material which can contain any desired further additives, for example a fiber reinforcement or a filler. Also conceivable are material mixtures containing a plastics material as the essential constituent part, for example as a binder. It is particularly preferred for the central layer to be formed homogenously from a single plastics material.

A plastics material is understood here to mean, in the first instance, any polymer and a substance formed by polymerization, wherein the monomers may be of both natural and synthetic origin. It is conceivable, in principle, here to use a single monomer and also a number of different monomers, which can form any desired copolymer. The polymer may also be a chain polymer or a branched polymer.

According to a preferred development, the composite member is designed to be dimensionally stable, in particular flexurally rigid and/or rigid when subjected to elongation, wherein the central layer is coated on either side by a respective outer layer. The joint load-bearing action results in the dimensional stability being improved, wherein loading and/or stressing is distributed as far as possible uniformly over the two outer layers and the central layer of the composite arrangement and is compensated for. In addition, this dimensionally stable arrangement achieves an improvement in the service life and/or durability and/or stability of the motor-vehicle components designed in the form of a composite member.

According to an advantageous development of the invention, the plastics material is a thermoplastic material, in particular a thermoplastic copolymer, as a result of which particularly straightforward and cost-effective production of the central layer of the composite member is made possible and, at the same time, improved deformability can be achieved as a result of the composite member being heated.

According to a particularly advantageous development of the invention, the plastics material is a viscoelastic plastics material, as a result of which, on the one hand, improved deformability of the material for producing the composite member is achieved and, on the other hand, the material properties of the composite member, in particular the rigidity thereof and its capability to absorb vibrations, can be set in a particularly straightforward manner.

In the case of a preferred configuration of the invention, one or both of the outer layers are formed from a sheet steel, as a result of which, on the one hand, particularly cost-effective production is made possible and, on the other hand, a high level of dimensional stability of the composite member is achieved, even if the metal sheets of the outer layers are of low material thickness.

It is possible, in principle, for the material thickness of the sheet metal to be selected as desired, in adaptation to the respective requirements which have to be met by the finished composite member. In the case of an advantageous configuration of the invention, the sheet metal has a material thickness of 0.1-1.5 mm, preferably of 0.15-0.5 mm and particularly preferably of 0.2-0.3 mm, wherein a high level of dimensional stability and a low overall weight of the composite member are advantageously achieved at the same time.

It is also possible for the central layer of the composite member to have, in principle, any desired layer thickness. In the case of an advantageous configuration of the invention, the material thickness of the central layer is between 0.02 and 1.5 mm, preferably between 0.1 and 1 mm and particularly preferably between 0.2 and 0.5 mm.

According to an advantageous configuration of the invention, one or both of the outer layers and/or the core layer have an essentially constant material thickness over their entire surface area, as a result of which all the regions of the composite member have more or less the same material properties, in particular a constant level of stability and rigidity.

According to a further advantageous configuration of the invention, the material thickness of the composite member is between 0.25 and 2 mm, preferably between 0.5 and 1.5 mm and particularly preferably between 0.6 and 1 mm.

According to a preferred development of the invention, the two outer layers of the composite member have differing material thicknesses, wherein the difference of the material thicknesses of the two outer layers is preferably between 10-30% and particularly preferably between 15-25%. By virtue of an asymmetric configuration of the construction of the composite member, it is possible, on the one hand, for the production of the composite member, for example by deep drawing, to be made readily easier and, on the other hand, for the respective surface of the composite member to be adapted to the forces acting thereon, wherein, at the same time, the overall weight of the composite member is straightforwardly kept at a low level.

According to a possible configuration of the invention, the ratio of the material thickness of the core layer to one or both, in particular each, of the two outer layers is between 2:1 and 4:1 and is preferably 3:1, this readily making it possible to achieve a particularly high level of flexural rigidity of the composite member.

According to a further possible configuration of the invention, the ratio of the material thickness of the core layer to one or both, in particular each, of the two outer layers is between 1:5 and 1:50, preferably between 1:10 and 1:25, this making it possible to optimize the sound-damping properties of the composite member.

According to a further advantageous configuration of the invention, one or both of the metal sheets has/have a corrosion-protection layer, in particular a zinc coating, arranged on the outside, this resulting in long-lasting and effective corrosion protection of the composite member.

According to a preferred development of the invention, individual regions, in particular peripheral regions, of the composite member are formed by folding, in particular roller hemming, as a result of which, on the one hand, increased stability is achieved and, on the other hand, there is a reduction in the risk of injury by sharp edges in particular in the peripheral regions.

According to a further preferred configuration, a seat shell of a motor-vehicle seat is produced from such a composite member, wherein the seat shell is particularly straightforward to produce in a cost-effective manner and likewise has a high level of dimensional stability and rigidity and withstands mechanical loading to particularly good effect and is of particularly low weight.

It is possible, in principle, for a number of the preferred configurations and developments of the invention mentioned above to be combined with one another as desired by a person skilled in the art, within the framework of his technical know-how and of what is technically possible.

Three exemplary embodiments of the invention will be explained in more detail hereinbelow.

A first embodiment of the invention relates to a single-piece seat shell which is intended for a motor-vehicle seat and is in the form of a sandwich-construction composite member made of a material composite. The composite member here has a central layer made of a thermoplastic copolymer and also outer layers, which are arranged on the outside of the central layer, on either side of the latter, and are each formed from a galvanized steel cover sheet.

The central layer here has a material thickness of 0.4 mm, whereas the two outer layers each have a material thickness of 0.2 mm. This gives rise to a symmetrical construction of the material of the composite member in a direction orthogonal to the surface thereof, wherein the composite member has an essentially constant material thickness of 0.8 mm over its entire surface area. On account of its construction, the composite member here is distinguished by a very high level of flexural rigidity.

The central layer is connected to each of the two outer layers integrally by adhesive bonding. In comparison with a compact metal sheet, arranging a central layer between the two outer layers here results, on the one hand, in a desirable reduction in weight and, on the other hand, in structure-borne-sound-damping properties, as well as improved elastic behavior, of the composite member.

The outer edges of the composite member are formed in each case by folding or crimping, this resulting in a reinforced peripheral region.

A second embodiment of the invention relates to a seat shell, or cushion shell, for a motor vehicle and differs from the first embodiment essentially in that the material construction is of asymmetrical configuration in a direction orthogonal to the surface of the composite member.

The central layer here has a material thickness of 0.6 mm and is constructed homogeneously from a thermoplastic copolymer. A first outer layer of the composite member has a material thickness of 0.2 mm, whereas a second outer layer, which is arranged on the opposite side of the central layer in relation to the first outer layer, has a material thickness of 0.25 mm.

A third embodiment of the invention relates to an engine hood formed in one piece as a composite member.

The composite member here has a central layer made of a permanently viscoelastic polymer with a layer thickness of 0.05 mm. The central layer has arranged on either side of it a respective outer layer made of steel cover sheets having a material thickness of 0.8 mm. Arranging such a central layer between the cover sheets results in optimized structure-borne-sound damping and airborne-sound insulation and thus in an improvement of the vehicle acoustics along with a simultaneously high level of stability of the composite member.

Exemplary embodiments of the invention will be explained in more detail hereinbelow with reference to drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1A is a schematic perspective view of a seat shell which is designed in the form of a composite member and belongs to a motor-vehicle seat;

FIG. 1B is a schematic sectional illustration of a first embodiment of the composite member;

FIG. 2A is a schematic perspective view of a seat shell which is designed in the form of a composite member and belongs to a motor-vehicle seat;

FIG. 2B is a schematic sectional illustration of a second embodiment of the composite member;

FIG. 3A is a schematic perspective view of an engine hood in the form of a composite member; and

FIG. 3B is a schematic sectional illustration of a third embodiment of the composite member.

### DESCRIPTION OF THE PREFERRED EMBODIMENTS

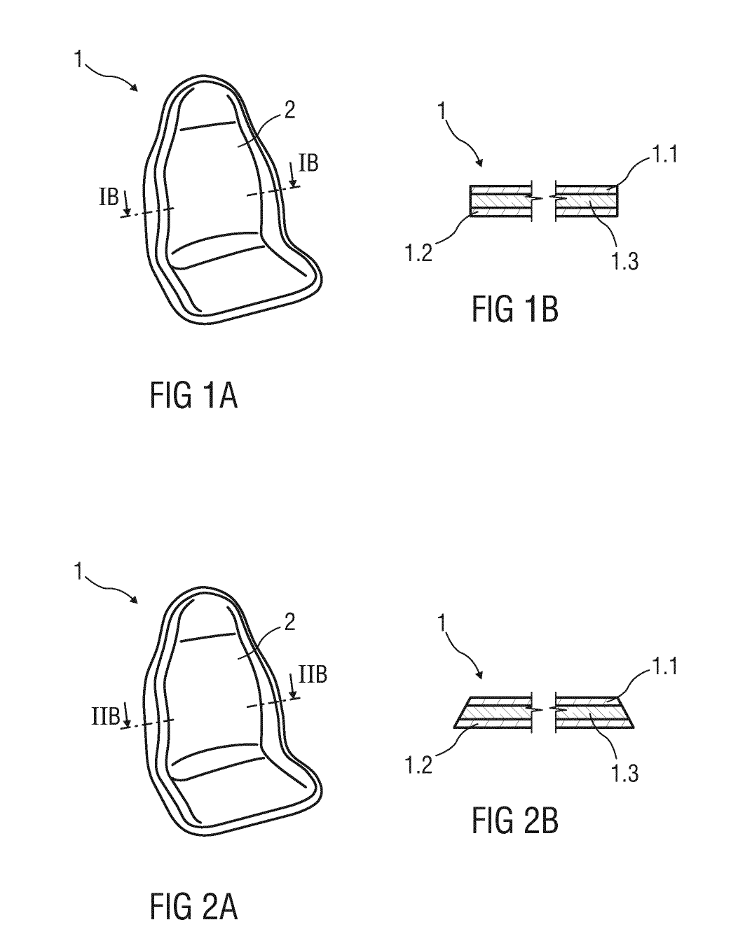

Referring to the drawings, FIGS. 1A and 2A each show a perspective view of a seat shell 2, or cushion shell, which is designed (configured) in the form of a composite member 1 and belongs to a seat of a motor vehicle (not illustrated specifically).

FIG. 1B illustrates a sectional illustration of a first embodiment of the composite member 1.

The composite member 1 comprises a central layer 1.3, which has an outer layer 1.1, 1.2 coating it on the inside and outside, wherein the outer layer 1.1, 1.2 is formed from a metal, in particular a galvanized steel cover sheet, and the central layer 1.3 is formed from a plastics material, in particular a thermoplastic copolymer. The composite member 1 here is of so-called sandwich construction, wherein the central layer 1.3, in particular a core layer, is connected on either side to a respective outer layer 1.1, 1.2 in each case in an integral, force-fitting and/or form-fitting manner, in particular in a tension-resistant and shear-resistant manner.

The central layer 1.3 here has a material thickness of 0.4 mm and the outer layers 1.1, 1.2 each have a material thickness of 0.2 mm, wherein there is a symmetrical construction of the material of the composite member 1 in a direction orthogonal to the surface thereof. A material thickness, in particular a material thickness of 0.8 mm, is constant essentially over an entire surface area of the composite member 1.

Outer edges (not illustrated specifically) of the composite member 1 are formed in each case for example by folding or crimping, this resulting in a reinforced peripheral region.

FIG. 2B shows a sectional illustration of a second embodiment of the composite member 1, wherein the composite member 1 is illustrated in a manner corresponding to the exemplary embodiment described in FIG. 1B.

In this exemplary embodiment, there is an asymmetrical construction of the material of the composite member 1 in a direction orthogonal to the surface thereof. A first outer layer 1.1 here has a material thickness of 0.2 mm and a second outer layer 1.2, which is located opposite the first outer layer 1.1, has a material thickness of 0.25 mm. The central layer 1.3, with a material thickness of 0.6 mm, is arranged between the first and the second outer layers 1.1, 1.2.

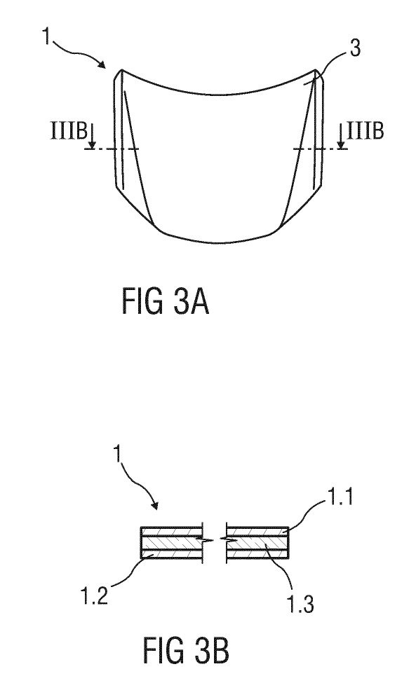

FIG. 3A shows a perspective view of an engine hood 3 designed in the form of a composite member 1, wherein FIG. 3B illustrates a sectional illustration of a third embodiment of the composite member 1.

The central layer 1.3 is formed from a permanently viscoelastic polymer and has a layer thickness of 0.05 mm, wherein the outer layers 1.1, 1.2 butting against the central layer 1.3 on either side is are formed from steel cover sheets and have a material thickness of 0.8 mm.

Arranging such a central layer 1.3 between two outer layers 1.1, 21.2 designed in the form of steel cover sheets results in optimized structure-borne-sound damping and airborne-sound insulation and thus in an improvement in vehicle acoustics.

While specific embodiments of the invention have been shown and described in detail to illustrate the application of the principles of the invention, it will be understood that the invention may be embodied otherwise without departing from such principles.

1. A composite member for producing motor-vehicle seats and motor-vehicle components, the composite member comprising:
a central layer; and
outer layers, which are arranged on the outside of the central layer, wherein the central layer is formed from a viscoelastic, thermoplastic copolymer and the outer layers are formed from a sheet metal.

2. The composite member as claimed in claim 1, wherein the composite member designed to be dimensionally stable, or flexurally rigid or rigid when subjected to elongation or any combination of dimensionally stable, flexurally rigid and rigid when subjected to elongation.

3. The composite member as claimed in claim 1, wherein the sheet metal has a material thickness of 0.1-1.5 mm.

4. The composite member as claimed in claim 1, wherein the central layer has a material thickness of 0.02-1.5 mm.

5. The composite member as claimed in claim 1, wherein one or both of the outer layers or the core layer or any combination of the outer layers and the core layer have an essentially constant material thickness over an entire surface area thereof.

6. The composite member as claimed in claim 1, wherein the composite member has a material thickness of 0.25-2 mm.

7. The composite member as claimed in claim 1, wherein the two outer layers have differing material thicknesses, wherein a difference of the material thicknesses of the two outer layers is between 10-30%.

8. The composite member as claimed in claim 1, wherein a ratio of a material thickness of the core layer to one or both of the outer layers is between 2:1 and 4.1.

9. The composite member as claimed in claim 1, wherein a ratio of a material thickness of the core layer to one or both of the outer layers is between 1:5 and 1.50.

10. The composite member as claimed in claim 1, wherein one or both of the metal sheets has/have a corrosion-protection layer comprising a zinc coating, arranged on the outside.

11. The composite member as claimed in claim 1, wherein individual peripheral regions, are formed by folding.

12. A seat shell produced from a composite member, the composite member comprising
a central layer formed from a viscoelastic, thermoplastic copolymer; and
outer layers arranged on the outside of the central layer, wherein the outer layers are formed from a sheet metal.

13. A seat shell as claimed in claim 12, wherein the composite member is configured to be dimensionally stable or flexurally rigid or rigid when subjected to elongation or any combination of dimensionally stable, flexurally rigid and rigid when subjected to elongation.

14. A seat shell as claimed in claim 12, wherein the sheet metal has a material thickness of 0.1-1.5 mm and the central layer has a material thickness of 0.02-1.5 mm.

15. A seat shell as claimed in claim 12, wherein one or both of the outer layers or the core layer or any combination of the outer layers and the core layer have an essentially constant material thickness over an entire surface area thereof.

16. A seat shell as claimed in claim 12, wherein the composite member has a material thickness of 0.25-2 mm.

17. A seat shell as claimed in claim 12, wherein the two outer layers have differing material thicknesses, wherein a difference of the material thicknesses of the two outer layers is between 10-30%.

18. A seat shell as claimed in claim 12, wherein the a ratio of a material thickness of the core layer to one or both of the outer layers is between 2:1 and 4:1.

19. A seat shell as claimed in claim 12, wherein a ratio of a material thickness of the core layer to one or both of the outer layers is between 1:5 and 1:50

20. A seat shell as claimed in claim 12, wherein one or both of the metal sheets has/have a corrosion-protection layer comprising a zinc coating, arranged on the outside.
